(19) United States
(12) Patent Application Publication
(10) Pub. No.: US 2006/0107567 A1
(43) Pub. Date: May 25, 2006

(54) Dynamic advertising display device

(76) Inventor: Shun I. Liao, Taichung (TW)

Correspondence Address: SHUN I. LIAO, P.O.Box 63-298, Taichung, 40699, TW

(21) Appl. No.: 10/995,984

(22) Filed: Nov. 22, 2004

(51) Int. Cl. G09F 11/12

(52) U.S. Cl. 40/524

(57) ABSTRACT

A dynamic advertising display device includes a housing having a number of rotatable rods and two followers attached to upper and lower portions of each rod, two transmission belts having projections engaged around the followers of the rods to couple the followers of the rods together, and two or more display panels coupled together to form an endless displaying member and attached to the belts, to allow the display panels to be moved in concert with the belts and to be moved around the rods. A driving device may drive the rods to move the display panels around the rods, for advertising purposes. The display panels may be detachably coupled together with hook and loop devices.

### BACKGROUND OF THE INVENTION

1. Field of the Invention

The present invention relates to a dynamic advertising display device, and more particularly to a dynamic advertising display device having easily and readily changeable advertising or display panels.

2. Description of the Prior Art

Various kinds of typical dynamic advertising display apparatuses have been developed and comprise a number of cards or advertising or display panels to be cyclicly or continuously moved or driven through a window, for allowing the cards or advertising or display panels to be cyclicly seen by people.

For example, the applicant has developed one of the typical dynamic advertising display apparatuses which has been issued as U.S. Pat. No. 6,363,638 to Liao, and also comprises a number of signboards to be cyclicly or continuously displayed by a number of signboard holders and a driving member, for cyclicly showing the signboards.

However, for holding or supporting the signboards, a number of signboard holders and a complicated driving member are required to be provided to drive or to move the signboards, and thus greatly complicate the manufacturing and the assembling of the typical dynamic advertising display apparatus.

U.S. Pat. No. 6,598,997 to Shyu discloses a typical light assembly having an endless color strap or belt member movably engaged around one or more light devices, for forming changeable colors or patterns.

However, the endless color strap or belt member is solidly attached to or around a number of posts, and may not be easily changed to the other color straps or belt members, such that the typical dynamic advertising display apparatuses may only be used to show or to display one sign or advertising. The users may have prepare a number of typical dynamic advertising display apparatuses to show or display various signs or advertisements.

The present invention has arisen to mitigate and/or obviate the afore-described disadvantages of the conventional dynamic advertising display devices.

### SUMMARY OF THE INVENTION

The primary objective of the present invention is to provide a dynamic advertising display device including a number of advertising or display panels that may be easily and readily changed to the other advertising or display panels.

In accordance with one aspect of the invention, there is provided a dynamic advertising display device comprising a housing including a number of rods rotatably disposed therein, each rod including two followers attached to upper and lower portions thereof respectively, two transmission belts engaged around the followers of the rods respectively, to couple the followers of the rods together, and to allow the belts to be rotated by the followers of the rods, a first display panel and at least one second display panel coupled together, to form an endless displaying member, and attached to the belts, to allow the display panels to be moved in concert with the belts and to be moved around the rods, and a driving device for driving the rods to move the display panels around the rods, for advertising purposes.

The display panels are detachably coupled together with hook and loop devices, for allowing the display panels to be easily and readily changed to the other display panels. The display panels each includes two bands attached to upper and lower portions thereof for reinforcing the display panels.

The display panels each includes a number of orifices formed in upper and lower portions thereof, and the belts each includes a number of engaging members attached thereto, for engaging through the orifices of the display panels, and for supporting the display panels of the endless displaying member between the transmission belts.

The engaging members may be hooks to engage with the display panels, and to anchor the display panels of the endless displaying member to the transmission belts.

The engaging members may also be pegs for engaging through the orifices of the display panels, and each includes a latch attached thereto to anchor and to retain the display panels to the transmission belts. The pegs each includes a slot formed therein, to slidably receive the latch therein, the latch includes a groove formed therein, and a pin engaged through the slot of the peg and the groove of the latch, to slidably retain the latch to the peg, and to allow the latch to be rotated to a position perpendicular to the peg, and thus to retain the display panels on the pegs, and to prevent the display panels from being disengaged from the pegs.

The display panels each includes a number of bars attached thereto, and having the engaging members provided on the bars. The bars each includes a notch formed therein, and a fastener engaged through the notch of each bar, to secure the bar to the display panels respectively.

The housing includes at least one light device disposed therein, to light the display panels, and to allow the display panels to be easily seen by people. The housing includes at least one detector attached thereto, to detect a rotational movement of the followers of the rods, and a control device disposed in the housing and coupled to the detector, to receive detected signals from the detector, and to control the display panels to move around the rods in predetermined time intervals, or continuously.

The followers each includes a number of cavities formed therein, the belts each includes a number of projections secured thereto with such as fasteners, for engaging with the cavities of the followers and for coupling the followers of the rods together, and thus for allowing the belts to be rotated or driven by the followers of the rods. The driving device includes a motor coupled to one of the rods, to drive the rods and the display panels and the transmission belts.

The housing includes at least one detector disposed therein to detect a rotational movement of the followers of the rods, and a control device disposed in the housing and coupled to the detector, to receive detected signals from the detector, and to control and to move the display panels.

A receptacle may further be provided and includes a hollow chamber formed therein to receive the housing therein, and including at least one window provided therein, for allowing the display panels to be seen through the window. The receptacle includes a door pivotally attached thereto with hinges, for entering into the hollow chamber of the receptacle. The display panels may be moved cyclicly in predetermined time intervals, or continuously through the window of the receptacle for displaying or advertising purposes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a dynamic advertising display device in accordance with the present invention;

FIG. 2 is a top plan schematic view of the dynamic advertising display device, in which a portion of the outer receptacle has been cut off, to show an inner structure of the dynamic advertising display device;

FIG. 3 is an enlarged partial top plan schematic view of the dynamic advertising display device;

FIG. 4 is a partial exploded view of the dynamic advertising display device;

FIG. 5 is another partial exploded view of the dynamic advertising display device;

FIG. 6 is a partial cross sectional view of the dynamic advertising display device, taken along lines 6-6 of FIG. 4;

FIG. 7 is a partial cross sectional view similar to FIG. 6, illustrating the operation of the dynamic advertising display device;

FIG. 8 is a top plan schematic view similar to FIG. 2, illustrating the other arrangement of the dynamic advertising display device; and

FIG. 9 is a top plan schematic view similar to FIGS. 2, 8, illustrating the further arrangement of the dynamic advertising display device.

### DETAILED DESCRIPTION OF THE PREFERRED EMBODIMENT

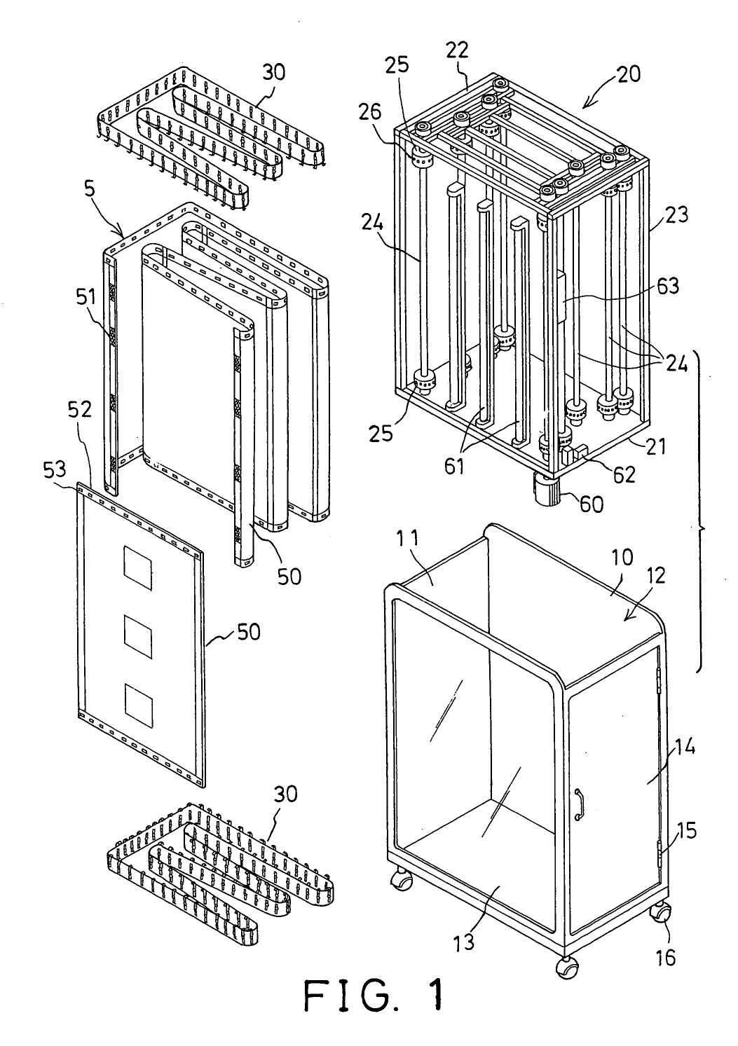

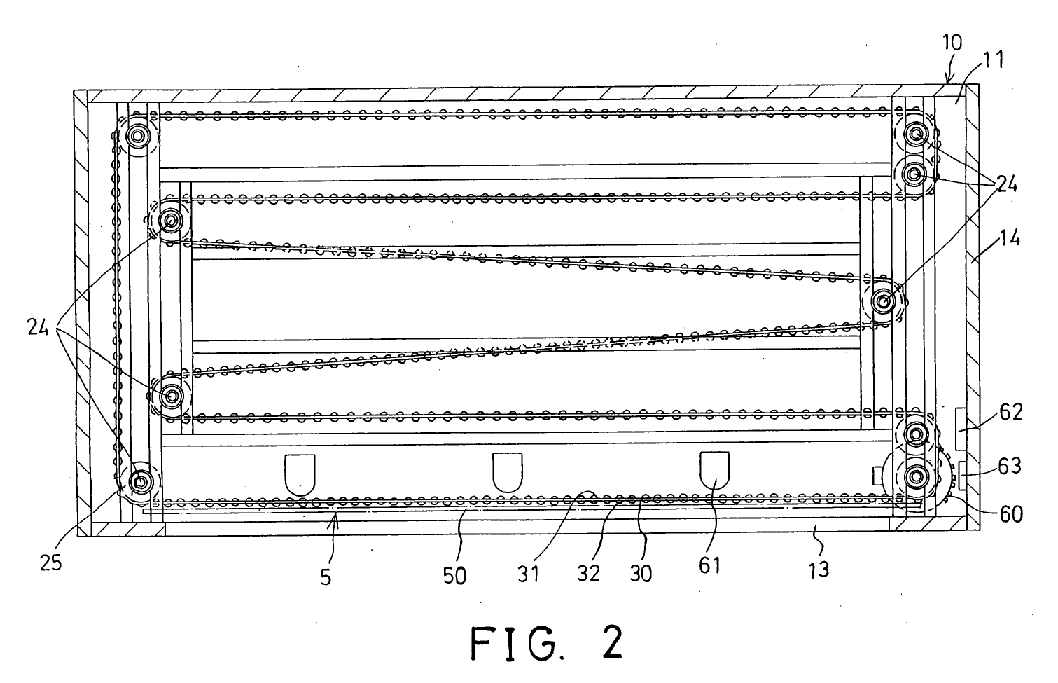

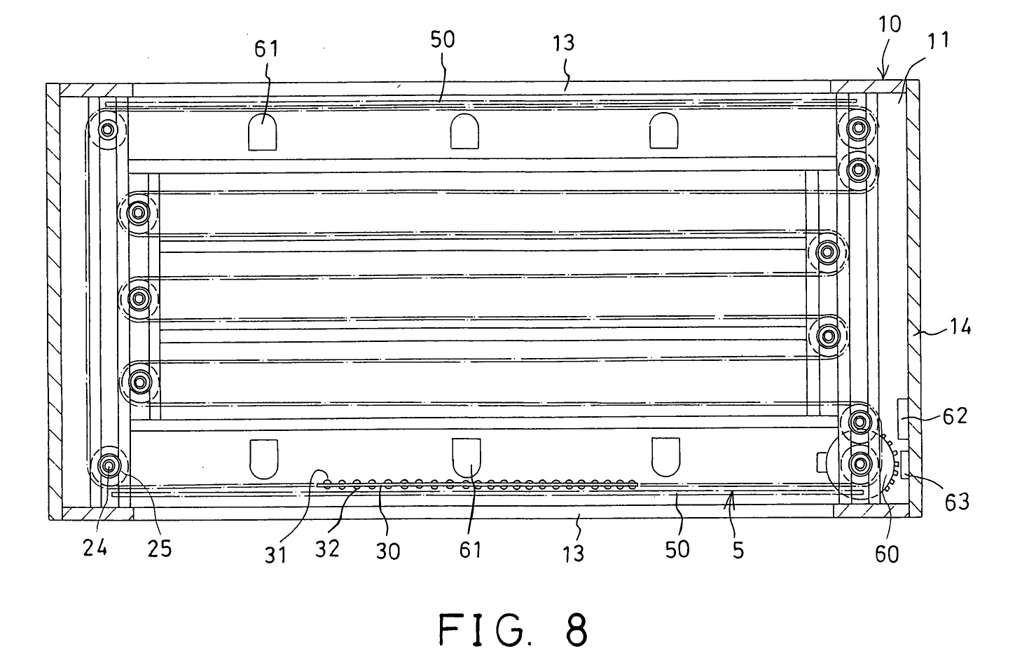

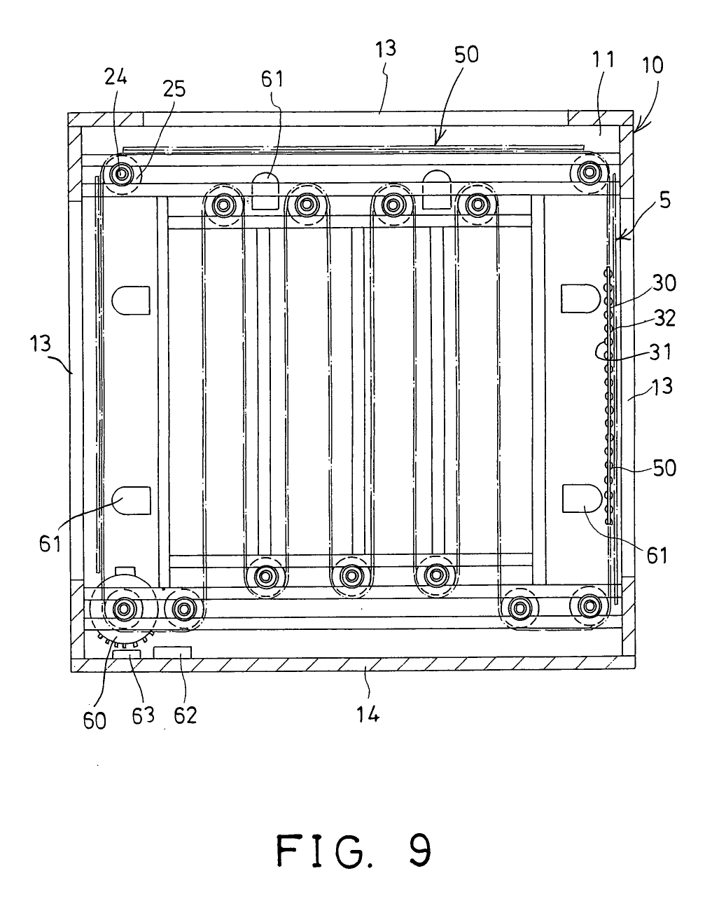

Referring to the drawings, and initially to FIGS. 1 and 2, a dynamic advertising display device in accordance with the present invention comprises an outer receptacle 10 including a hollow chamber 11 formed therein and having an open top 12 for receiving a housing 20 therein, and including one (FIGS. 1, 2) or more (FIGS. 8, 9) windows 13 formed or provided on sides or outer peripheral portion thereof.

The receptacle 10 may include a door 14 pivotally attached thereto with such as hinges 15 (FIG. 1), for entering into the hollow chamber 11 of the receptacle 10, and/or for repairing the parts or elements received in the chamber 11 of the receptacle 10. The receptacle 10 may further include one or more wheels 16 rotatably attached to bottom portion thereof, for allowing the receptacle 10 to be easily moved by the users.

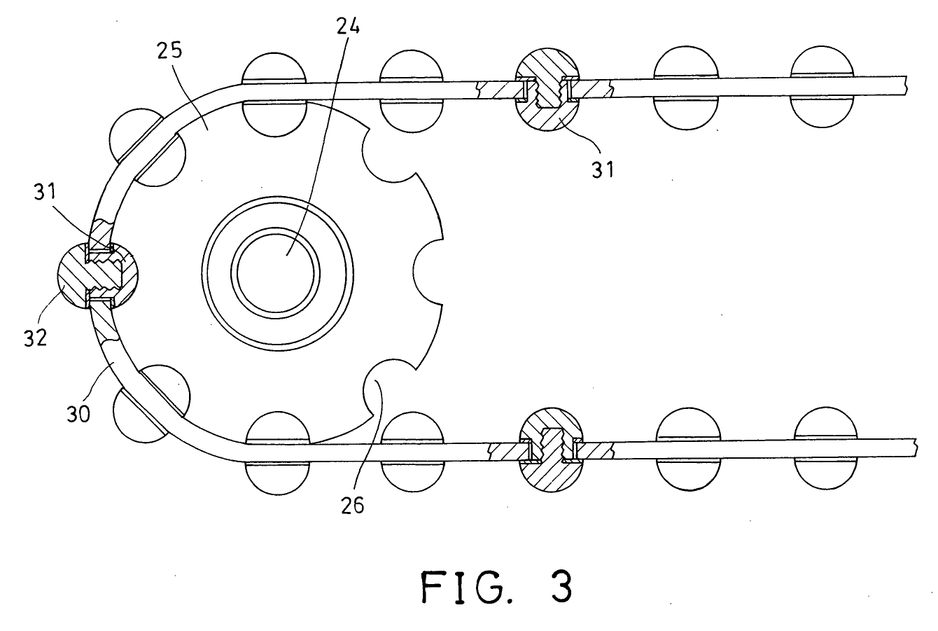

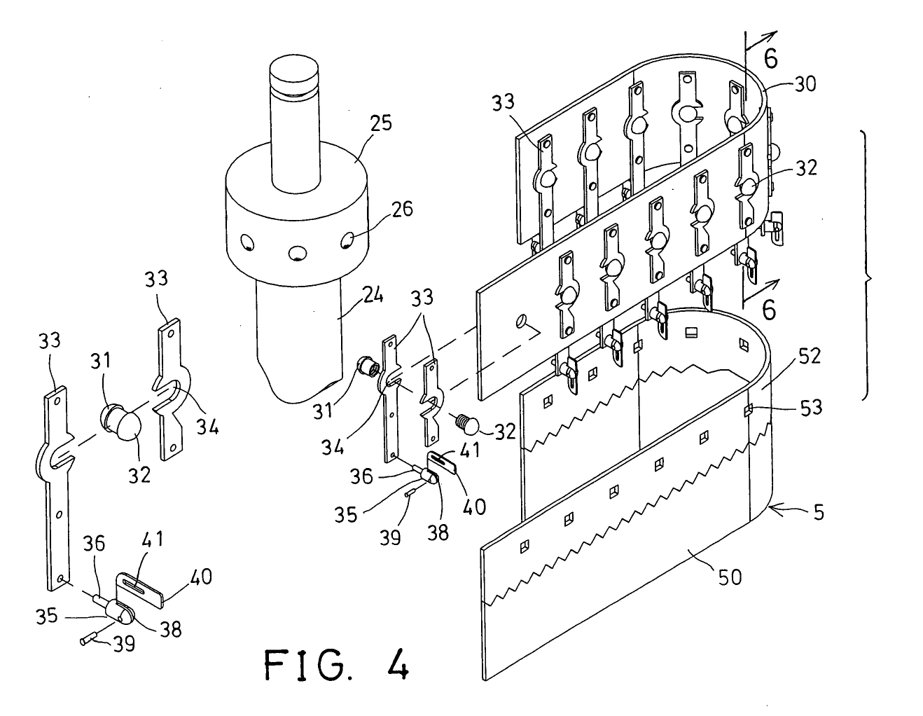

The housing 20 includes a lower or bottom board 21, an upper frame 22, and one or more posts 23 disposed or secured between the bottom board 21 and the upper frame 22, for forming a spatial or a parallelepiped structure. A number of rods 24 are rotatably disposed or secured in the housing 20, or attached between the bottom board 21 and the upper frame 22, and each includes two wheels or followers 25 attached to the upper and the lower portions thereof respectively, and each follower 25 includes a number of cavities 26, such as semi-spherical cavities 26 formed in an outer peripheral portion thereof (FIGS. 3, 4).

One or more, such as two transmission belts 30 are provided for carrying one or more advertising or display panels 50, and to be engaged around the followers 25 of the rods 24, and each includes a number of projections 31 secured thereto with such as fasteners 32, and equally spaced away from each other, for engaging with the cavities 26 of the followers 25, and thus for allowing the followers 25 of the rods 24 to be coupled together with the belts 30, and thus for allowing the belts 30 to be rotated or driven by the followers 25 of the rods 24.

The belts 30 may thus be made of flexible rubber or plastic or leather materials. One or more, such as two bars 33 may further be provided and each may include a notch 34 formed therein, for receiving the projections 31 or the fasteners 32, and for being secured to the belts 30 with the projections 31 and the fasteners 32. The bars 33 may be made of metal or stronger plastic materials, for reinforcing the belts 30, or for preventing the belts 30 from being damaged or broken by the projections 31 and the fasteners 32.

Two or more advertising or display panels 50 may be detachably secured or coupled together with fasteners, latches, hook and loop devices 51, or other coupling devices 51, in order to form an endless displaying member 5 (FIGS. 2, 8, 9), and to be attached to and moved in concert with the belts 30, and thus to be moved around the rods 24 and the followers 25. Each display panel 50 preferably includes two bands 52 attached or secured to the upper and the lower portions thereof by such as stitches, adhesive materials, or the like, for reinforcing the upper and the lower portions thereof, and a number of orifices 53 formed in each band 52.

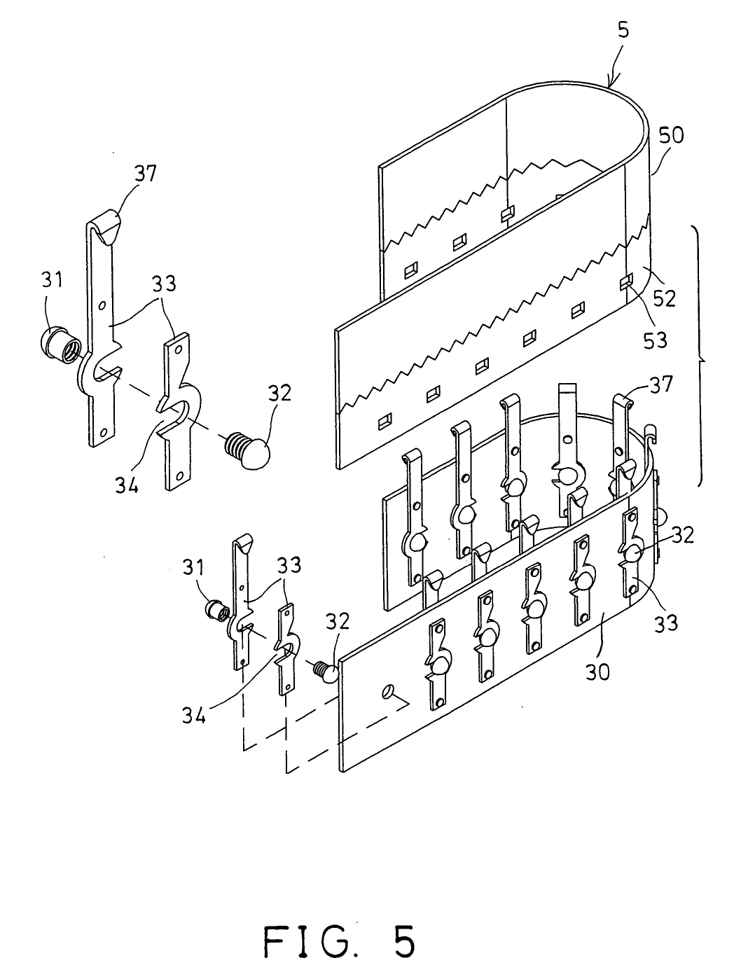

A number of engaging members 35, such as pegs 35 are attached or secured to the upper belt 30 by the bars 33 and/or by rivets 36, for engaging into or through the orifices 53 of the upper bands 52 or of the display panels 50, and a number of further engaging members 37, such as hooks 37 (FIG. 5) may further be provided or formed on either or both of the bars 33 of the lower belt 30 for engaging into or through the orifices 53 of the lower bands 52 or of the display panels 50, and for engaging with the display panels 50, and thus for anchoring or suspending or holding or supporting the display panels 50 of the endless displaying member 5 between the transmission belts 30.

As shown in FIGS. 4 and 6-7, each of the pegs 35 preferably includes a slot 38 formed therein, for slidably receiving a latch 40 therein which includes an oblong hole or groove 41 formed therein, and includes a pin 39 attached thereto and engaged through the slot 38 of the peg 35 and the groove 41 of the latch 40, for attaching or retaining the latch 40 to the respective peg 35.

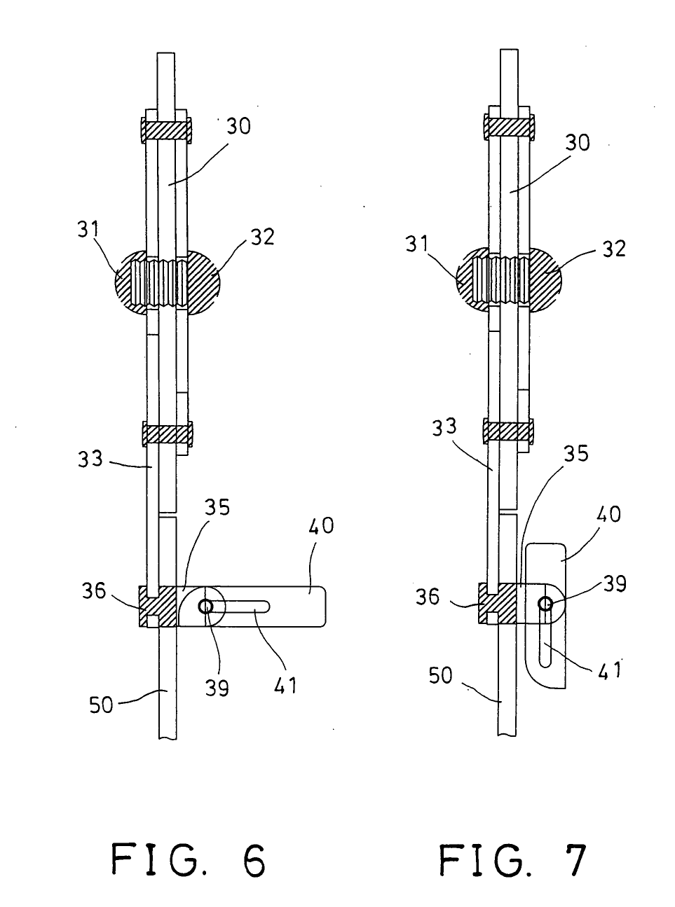

As shown in FIG. 6, the latches 40 may be arranged parallel to or in line with the pegs 35, to allow the latches 40 and the pegs 35 to be engaged into the orifices 53 of the upper bands 52 or of the display panels 50. As shown in FIG. 7, the latches 40 may also be arranged perpendicular to the pegs 35, to allow retain or to position the display panels 50 on the pegs 35, and to prevent the display panels 50 from being disengaged from the pegs 35 and the transmission belts 30.

As shown in FIGS. 1-2 and 8-9, a driving means or a motor 60 may be attached to the housing 20, and coupled to one of the rods 24, in order to rotate or to drive the rods 24 and thus the display panels 50 and the transmission belts 30, in order to cyclicly move the display panels 50 through the windows 13 of the receptacle 10 (FIGS. 2, 8, 9), for displaying or advertising purposes. A number of light devices 61 may further be provided and disposed in the housing 20, or disposed behind the display panels 50 and the windows 13 of the receptacle 10, to allow the patterns or advertisements on the display panels 50 to be clearly seen through the windows 13 of the receptacle 10.

One or more detectors 62 may further be provided and disposed in the housing 20, or disposed beside one of the followers 25 of the rods 24, to sense or detect the rotational movement of the followers 25 or of the rods 24, and a control device 63 may also be provided and disposed in the housing 20, and coupled to the detectors 62, to receive detected signals from the detectors 62, and to control or to move the display panels 50 cyclicly through the windows 13 of the receptacle 10. For example, the display panels 50 may be cyclicly moved through the windows 13 of the receptacle 10 in predetermined time intervals.

In operation, as shown in FIGS. 2 and 8-9, the display panels 50 may be moved cyclicly in predetermined time intervals, or continuously through the windows 13 of the receptacle 10 for displaying or advertising purposes, by the motor 60 via the rods 24 and the followers 25 and the transmission belts 30. The light devices 61 may be used to light the display panels 50, and to allow the patterns or advertisements on the display panels 50 to be clearly seen through the windows 13 of the receptacle 10 and to be clearly seen by people.

It is to be noted that the endless displaying member 5 may include two or more advertising or display panels 50 that may be easily and readily secured or coupled together with the hook and loop devices 51 or other coupling devices 51, to allow the display panels 50 to be easily changed with the other ones, when required, without disassembling the rods 24 and the followers 25 from the housing 20.

Accordingly, the dynamic advertising display device in accordance with the present invention includes a number of advertising or display panels that may be easily and readily changed to the other advertising or display panels.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A dynamic advertising display device comprising:
a housing including a plurality of rods rotatably disposed therein, each rod including two followers attached to upper and lower portions thereof respectively,
two transmission belts engaged around said followers of said rods respectively, to couple said followers of said rods together, and to allow said belts to be rotated by said followers of said rods,
a first display panel and at least one second display panel coupled together, to form an endless displaying member, and attached to said belts, to allow said first and said at least one second display panels to be moved in concert with said belts and to be moved around said rods, and
means for driving the rods to move said first and said at least one second display panels around said rods, for advertising purposes.

2. The dynamic advertising display device as claimed in claim 1, wherein said first and said at least one second display panels are detachably coupled together with hook and loop devices.

3. The dynamic advertising display device as claimed in claim 1, wherein said first and said at least one second display panels each includes two bands attached to upper and lower portions thereof for reinforcing said first and said at least one second display panels.

4. The dynamic advertising display device as claimed in claim 1, wherein said first and said at least one second display panels each includes a plurality of orifices formed in upper and lower portions thereof, and said belts each includes a plurality of engaging members attached thereto, for engaging through said orifices of said first and said at least one second display panels, and for supporting said first and said at least one second display panels of said endless displaying member between said transmission belts.

5. The dynamic advertising display device as claimed in claim 4, wherein said engaging members are hooks to engage with said first and said at least one second display panels, and to anchor said first and said at least one second display panels of said endless displaying member to said transmission belts.

6. The dynamic advertising display device as claimed in claim 4, wherein said engaging members are pegs for engaging through said orifices of said first and said at least one second display panels, and each includes a latch attached thereto to anchor and to retain said first and said at least one second display panels to said transmission belts.

7. The dynamic advertising display device as claimed in claim 6, wherein said pegs each includes a slot formed therein, to slidably receive said latch therein, said latch includes a groove formed therein, and a pin engaged through said slot of said peg and said groove of said latch, to slidably retain said latch to said peg.

8. The dynamic advertising display device as claimed in claim 4, wherein said first and said at least one second display panels each includes a plurality of bars attached thereto, and having said engaging members provided on said bars.

9. The dynamic advertising display device as claimed in claim 8, wherein said bars each includes a notch formed therein, and a fastener engaged through said notch of each bar, to secure said bar to said first and said at least one second display panels respectively.

10. The dynamic advertising display device as claimed in claim 1, wherein said housing includes at least one light device disposed therein, to light said first and said at least one second display panels.

11. The dynamic advertising display device as claimed in claim 1, wherein said housing includes at least one detector attached thereto, to detect a rotational movement of said followers of said rods, and a control device disposed in said housing and coupled to said at least one detector, to receive detected signals from said at least one detector, and to control said first and said at least one second display panels to move around said rods.

12. The dynamic advertising display device as claimed in claim 1, wherein said followers each includes a plurality of cavities formed therein, said belts each includes a plurality of projections secured thereto for engaging with said cavities of said followers and for coupling said followers of said rods together, and for allowing said belts to be driven by said followers of said rods.

13. The dynamic advertising display device as claimed in claim 1, wherein said driving means includes a motor coupled to one of said rods, to drive said rods and said first and said at least one second display panels and said transmission belts.

14. The dynamic advertising display device as claimed in claim 1, wherein said housing includes at least one detector disposed therein to detect a rotational movement of said followers of said rods, and a control device disposed in said housing and coupled to said at least one detector, to receive detected signals from said at least one detector, and to control said first and said at least one second display panels.

15. The dynamic advertising display device as claimed in claim 1 further comprising a receptacle including a hollow chamber formed therein to receive said housing therein, and including at least one window provided therein, for allowing said first and said at least one second display panels to be seen through said at least one window.

16. The dynamic advertising display device as claimed in claim 15, wherein said receptacle includes a door pivotally attached thereto with hinges, for entering into said hollow chamber of said receptacle.
